(19) United States
(12) Patent Application Publication
(10) Pub. No.: US 2010/0321723 A1
(43) Pub. Date: Dec. 23, 2010

(54) Image processing apparatus and device control method

(75) Inventor: Kenji Nishimura, Tokyo (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/662,392

(22) Filed: Apr. 14, 2010

(30) Foreign Application Priority Data
Jun. 17, 2009 (JP) 2009-144430

(51) Int. Cl. G06F 15/00

(52) U.S. Cl. 358/1.15

(57) ABSTRACT

An image processing apparatus having a display device having a control section is disclosed. The image processing apparatus includes a request unit sending a request from the display device to the image processing apparatus to execute a device control process, the request being processed based on a program executed by a browser running in the display device; an execution unit executing the device control process requested by the display unit, the execution being performed based on a program processed by a Web server running in the image processing apparatus; and a response unit sending an execution result of the device control process to the display unit.

### CROSS-REFERENCE TO RELATED APPLICATIONS

The present application claims priority under 35 U.S.C §119 based on Japanese Patent Application No. 2009-144430 filed Jun. 17, 2009, the entire contents of which are hereby incorporated herein by reference.

### BACKGROUND OF THE INVENTION

1. Field of the Invention

The present invention generally relates to an image processing apparatus having a display device, and more particularly to a technique to control the apparatus in which different CPUs (Central Processing Units) are provided in the display device and the image processing apparatus.

2. Description of the Related Art

Generally, an image processing apparatus has plural applications (functions) such as a copier, a printer, a fax machine, a scanner and the like, and provides display menus (application menus) for the respective functions, the menus displaying a GUI (Graphical User Interface) for setting the respective functions and information about operations of the functions. Such an image processing apparatus has a display control function to control the display menu in response to an operation status and a request from a user of the image processing apparatus. Recently, display functions in such image processing apparatuses have been improving over time.

For example, Japanese Patent Application Publication No. 2008-158493 discloses a technique in which HTML (HyperText Markup language) contents and compound contents including moving images and still images are stored in a recording device, so that the HTML contents are displayed using a browser and the compound contents are displayed using the Flash Player (registered trademark).

However, in a conventional image processing apparatus, device control (e.g., execution of a function based on user's instruction) using a display menu may not be sufficiently adapted to an image processing apparatus in which different CPUs are separately provided in the display device and in the image processing apparatus excluding the display device (hereinafter simplified as image processing apparatus).

Namely, in a conventional image processing apparatus, the device control is performed by using the CPU of the image processing apparatus. For example, in the image processing apparatus described in the above Japanese Patent Application Publication No. 2008-158493, the browser and the device control (e.g., execution of a function based on user's instruction) received via the browser are executed by using the CPU of the image processing apparatus (not by using the CPU of the display device).

However, with the improvement of the functions of the display device, more and more image processing apparatuses have a dedicated (separate) CPU in their display devices in addition to the CPU in the image processing apparatuses. In this case, however, the browser may not call (i.e., execute) a module for executing a process of device control of the image processing apparatus (hereinafter, such module may be referred to as a “device control code”). Because of this feature, it may become necessary to divide the entire device control functions into two parts, one for the display device and the other for the image processing apparatus, and both device control functions may be required to be newly implemented (developed). This process may be complex for the development engineer, because the process may increase the developing cost.

### SUMMARY OF THE INVENTION

The present invention is made in light of the above circumstance and may provide an image processing apparatus and a device control method capable of performing device control via a display menu, the apparatus and the method providing at least one of the following benefits: fewer development man-hours, reduced development time, reduced development cost, fewer deficiencies, and better productivity.

According to a first aspect of the present invention, an image processing apparatus having a display device having a control section is disclosed. The image processing apparatus includes a request unit sending a request from the display device to the image processing apparatus to execute a device control process, the request being processed based on a program executed by a browser running in the display device, an execution unit executing the device control process requested by the display unit, the execution being performed based on a program processed by a Web server running in the image processing apparatus, and a response unit sending an execution result of the device control process to the display unit.

By having this configuration, in the image processing apparatus according to this aspect of the present invention, a communication code executed by the browser running in the display device is used to transmit the request to perform device control to the Web server running in the controller of the image processing apparatus. Further, in the image processing apparatus, a servlet running in the Web server calls the device control code corresponding to the request, and an execution result of the device control is transmitted back (sent) to the requestor (i.e., browser).

By having this configuration, in an image processing apparatus having a display device according to an aspect of the present invention, when the image processing apparatus and the display device have the corresponding (separate) control sections (CPUs), it may become possible to perform device control from the browser in the display unit while using (without changing) existing device control codes. As a result, it may become possible to reduce the workload of the designer (development engineer) when compared with the case where new development is required.

According to a second aspect of the present invention, there is provided a device control method in an image processing apparatus having a display device having a control section. The device control method includes a requesting step of the display device requesting to the image processing apparatus to execute a device control process, the request being processed based on a program executed by a browser running in the display device, an executing step of executing the device control process requested from the display unit, the execution being performed based on a program processed by a Web server running in the image processing apparatus; and a responding step of sending with execution result of the device control process to the display unit.

In the method according to the aspect of the present invention, the communication code executed by the browser running in the display device is used to transmit the request to perform device control to the Web server running in the controller of the image processing apparatus. Further, in the image processing apparatus, a servlet running in the Web server calls the device control code corresponding to the request, and an execution result of the device control is transmitted back (reported) to the requestor (i.e., browser).

By executing the device control method according to the aspect of the present invention, even when the image processing apparatus and the display device have the corresponding (separate) control sections (CPUs), it may become possible to perform device control using a display menu with simper operations.

### BRIEF DESCRIPTION OF THE DRAWINGS

Other objects, features, and advantages of the present invention will become more apparent from the following description when read in conjunction with the accompanying drawings, in which:

FIG. 1 is a drawing showing an exemplary hardware configuration of an image processing apparatus according to an embodiment of the present invention;

FIG. 2 is a drawing showing an exemplary hardware configuration of a display device according to the embodiment of the present invention;

FIG. 3 is a drawing showing an exemplary software configuration of the image processing apparatus having the display device according to the embodiment of the present invention;

FIG. 4 is a drawing showing a software configuration of conventional display control;

FIG. 5 is a drawing showing an exemplary software configuration of display control according to the embodiment of the present invention;

FIG. 6 is a drawing showing an exemplary configuration of a device control function according to the embodiment of the present invention;

FIG. 7 is a drawing showing an example of data of a communication interface according to the embodiment of the present invention;

FIGS. 8A and 8B are drawings showing first examples of request data and response data, respectively, according to the embodiment of the present invention;

FIGS. 9A and 9B are drawings showing second examples of the request data and the response data, respectively, according to the embodiment of the present invention;

FIGS. 10A and 10B are drawings showing third examples of the request data and the response data, respectively, according to the embodiment of the present invention;

FIGS. 11A and 11B are a sequence diagram showing a process of the device control of an initial operation according to the embodiment of the present invention;

FIGS. 12A and 12B are drawings showing first examples of display menus during the operation according to an embodiment of the present invention;

FIGS. 13A and 13B are a sequence diagram showing a process of device control of a functional operation according to the embodiment of the present invention; and

FIGS. 14A and 14B are drawing showing second examples of display menus during the operation according to an embodiment of the present invention.

### DETAILED DESCRIPTION OF THE PREFERRED EMBODIMENTS

In the following, a preferred embodiment of the present invention is described with reference to the accompanying drawings.

### Hardware Configuration

First, hardware configurations of an image processing apparatus and a display device of the image processing apparatus according to an embodiment of the present invention are described.

### Image Processing Apparatus

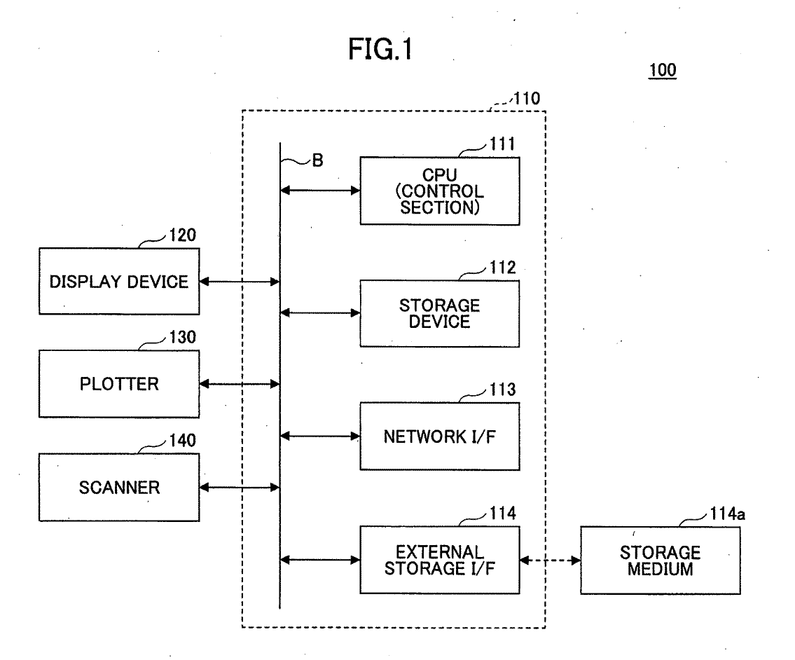

FIG. 1 shows an exemplary hardware configuration of an image processing apparatus 100 according to the embodiment of the present invention. As shown in FIG. 1, the image processing apparatus 100 includes a controller 110, a display device 120, a plotter 130, a scanner 140 and the like, and these elements are mutually connected via a bus B.

The display device 120 includes a display section and an input section such as a touch panel so that the display device 120 provides a user with various information items such as device information, and receives various user's operations such as operation settings and operation instructions. The plotter 130 includes an image forming section to form an output image on a sheet. As the method of forming the output image, the electrophotographic processing method, the inkjet method or the like may be used. The scanner 140 reads a document optically, and forms a read image.

As shown in FIG. 1, the controller 110 includes a CPU 111, a storage device 112, a network I/F (interface) 113, an external storage I/F 114 and the like, and these elements are mutually connected via the bus B.

The CPU 111 realizes (executes) various functions and controls the entire apparatus by executing the respective programs. As the storage device 112, a RAM (Random Access Memory) which is a volatile memory device, a ROM (Read Only Memory) which is a non-volatile memory device, a HDD (Hard Disk Drive) having larger storage capacity or the like may be used. The RAM may serve as a working area of the CPU 111 (i.e., a storage area where a program and data are temporarily read out). The ROM and the HDD may be used as media for storing programs and various data. By having this configuration in the image processing apparatus 100, the CPU 111 loads a program stored in the ROM into the RAM, and executes the program.

The network I/F 113 is used to connect the image processing apparatus 100 to a predetermined data transmission path such as a network. The external storage I/F 114 is used so that the image processing apparatus 100 is connected to a storage medium 114a serving as an external storage device. As the external storage device, an SD Memory Card, a USB (Universal Serial Bus) memory or the like may be used. By having the above configuration, the image processing apparatus 100 may read programs and data stored in the storage medium 114a.

In the above hardware configuration, for example, upon receiving an instruction to execute a copy function via the input section of the display device 120, the image processing apparatus 100 performs the following device control (procedure). First, the controller 110 performs scan execution control so that the scanner 140 reads an image on a draft, and generates a read image. Next, the image processing apparatus 100 transfers the generated read image to the controller 110. Then, based on the read image, the controller 110 generates a raster image (bit map image). Finally, the controller 110 performs plot execution control so that the plotter 130 forms a toner image on a sheet. By doing in this way, the image processing apparatus 100 realizes (performs) the copy function.

### Display Device

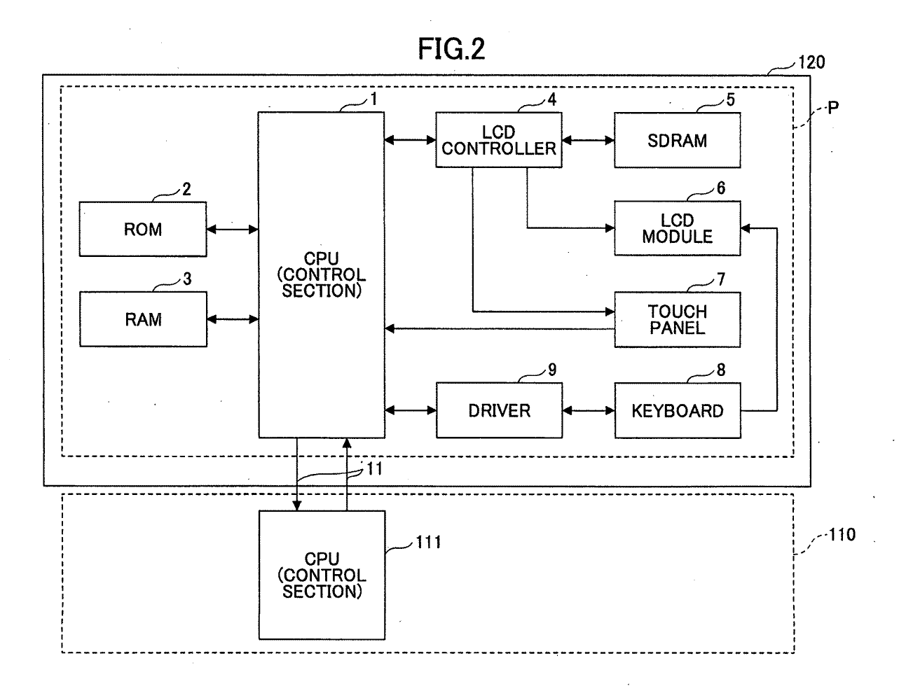

FIG. 2 shows an exemplary hardware configuration of the display device 120 according to the embodiment of the present invention. As shown in FIG. 2, the display device 120 includes a control substrate P on which a dedicated CPU 1 an the like are mounted, the CPU 1 being independent of (different from) the CPU 111 of the controller 110 of the image processing apparatus 100. The CPU 1 of the display device 120 is connected with the CPU 111 of the controller 110 via a communication link 11 using synchronous serial communication (such as the USB). By connecting in this way, the CPU 1 and the CPU 111 may communicate with each other, transmitting key input information from the input section of the display device 120 (request data of device control), display information from the image processing apparatus 100 (response data of the device control) and the like.

As shown in FIG. 2, the CPU 1 is connected to a ROM 2 and a RAM 3, the ROM 2 storing various programs to realize (execute) input and output processes and data, the RAM 3 serving as a working area of the CPU 1. Further, the CPU 1 is connected to an LCD (Liquid Crystal Display) controller 4, a touch panel 7, a driver 9 and the like. The LCD controller 4 controls an LCD module 6. The touch panel 7 is provided (formed) on a display section of the LCD module 6. The driver 9 is used for a keyboard 8.

The CPU 1 may read data from and write data to an SDRAM (Synchronous Dynamic Random Access Memory) 5 via the LCD controller 4, the SDRAM 5 being a video RAM (VRAM) storing display pixel data of the LCD module 6. Further, the CPU 1 may control switches (SWs) and LEDs (Light Emitting Diodes) on the keyboard 8 via the driver 9, and control the backlights of the LCD module 6.

The LCD controller 4 refreshes the SDRAM 5, and transmits the display data (outputs a display signal) from the SDRAM 5 to the LCD module 6. In this case, the LCD controller 4 may control the output of the signal based on a setting in an internal register. Further, the LCD controller 4 has a touch panel I/F function. Namely, when a part of the touch panel 7 is pressed down (touched), the LCD controller 4 transmits the corresponding interrupt signal to the CPU 1.

Further, on the control substrate P of the display device 120, there is provided a connection link (not shown) such as a card slot to be connected to a storage medium (e.g., a flash memory) such as an IC (Integrated Circuit) card, so that the data can be read from the storage medium. The connection link includes an input port that can detect whether the storage medium is connected.

By having the above configuration, the display device 120 may receive various information items indicating the execution status of various functions of the image processing apparatus 100, conditional settings of executing operations and the like. Further, the display device 120 displays operating information of the various functions, status information of the apparatus, job information and the like on a menu to notify a user of those information items.

### Software Configuration

Next, a software configuration of the image processing apparatus 100 according to the embodiment of the present invention is described.

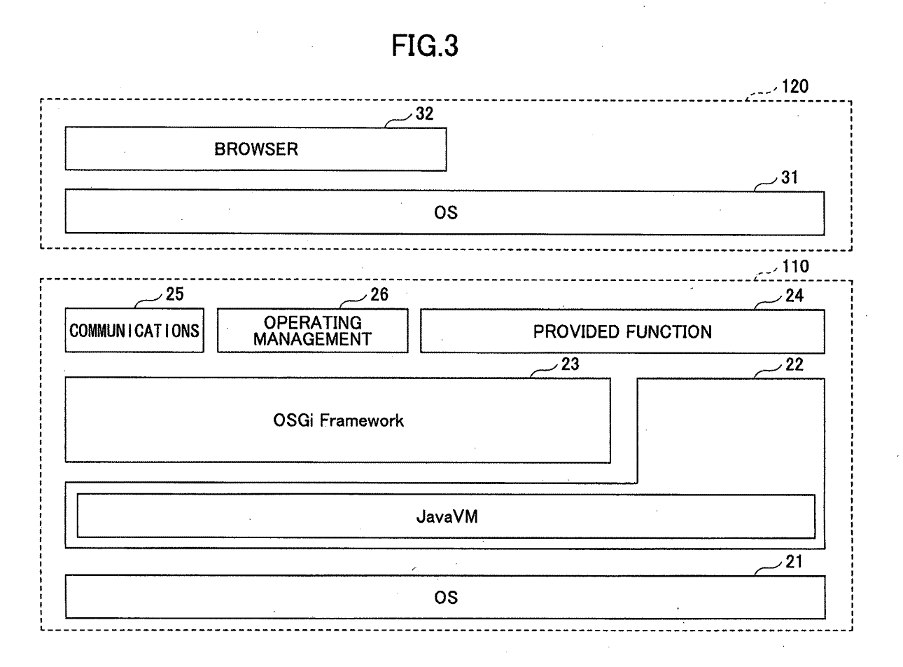

FIG. 3 shows an exemplary software configuration of the image processing apparatus 100 according to the embodiment of the present invention.

As shown in FIG. 3, an Embedded Operating System 31 (hereinafter simplified as “OS 31”), which is basic software controlling the entire display device 120, runs in the display device 120 of the image processing apparatus 100. As the OS 31, for example, the Linux (registered trademark) OS may be used. Further, a browser 32 runs on the OS 31. In this embodiment, an example is described where an embedded browser is mounted.

On the other hand, an Embedded Operating System 21 (hereinafter simplified as “OS 21”), which is basic software controlling the entire image processing apparatus 100, runs in the controller 110 of the image processing apparatus 100. Further, a virtual machine (VM) runs on the OS 21. In this embodiment, an example is described where a Java (registered trademark) VM 22 is mounted. The Java VM 22 is a software environment where Java byte-code is converted into a native code of the platform and executed. Namely, the Java VM 22 is a virtual machine (VM) for executing an instruction set defined by the Java language.

Further, as shown in FIG. 3, an OSGi Framework (Open Service Gateway initiative Framework) 23 runs on the Java VM 22. The OSGi Framework 23 is a framework providing a library to be used to implement a standard structure of an application running on a Java-based service platform. By having this framework, it becomes possible to run a software group (OSGi-provided service group) on the OSGi Framework 23, the software group performing an expanded function developed based on the framework. As examples of the expanded function, as shown in FIG. 3, there are communications 25, operating management 26 and the like. For example, in this embodiment, the software is programmed by using the Java language (e.g., “Java script”).

Further, as shown in FIG. 3, a provided function 24 runs on the Java VM 22 or the OSGi Framework 23. The provided function 24 is a software group to perform basic functions (i.e., functions developed by the supplier of the image processing apparatus 100) such as the functions of copier, printer, facsimile machine, scanner and the like. Therefore, in the image processing apparatus 100 according to the embodiment of the present invention, device control code (i.e., a module to perform device control for a device) is assumed to be included in the provided function 24.

By having the above software configuration, the image processing apparatus 100 receives a device control request (device execution request) from a user via the, browser 32 running in the display device 120, and executes the device control code included in the provided function 24 by using the controller 110 of the image processing apparatus 100. By doing in this way, the image processing apparatus 100 performs the function of device control (device control function).

### Device Control Function

Next, the device control function performed in the image processing apparatus 100 according to the embodiment of the present invention is described.

In the image processing apparatus 100 according to the embodiment of the present invention, a communication code executed by the browser 32 running in the display device 120 is used to transmit a request to a Web server running in the controller 110 of the image processing apparatus 100 to perform device control. Next, in the image processing apparatus 100, a servlet running in the Web server calls the device control code corresponding to the request, and an execution result of the device control is transmitted back to the requestor (i.e., browser 32). The image processing apparatus 100 has the device control function as described above.

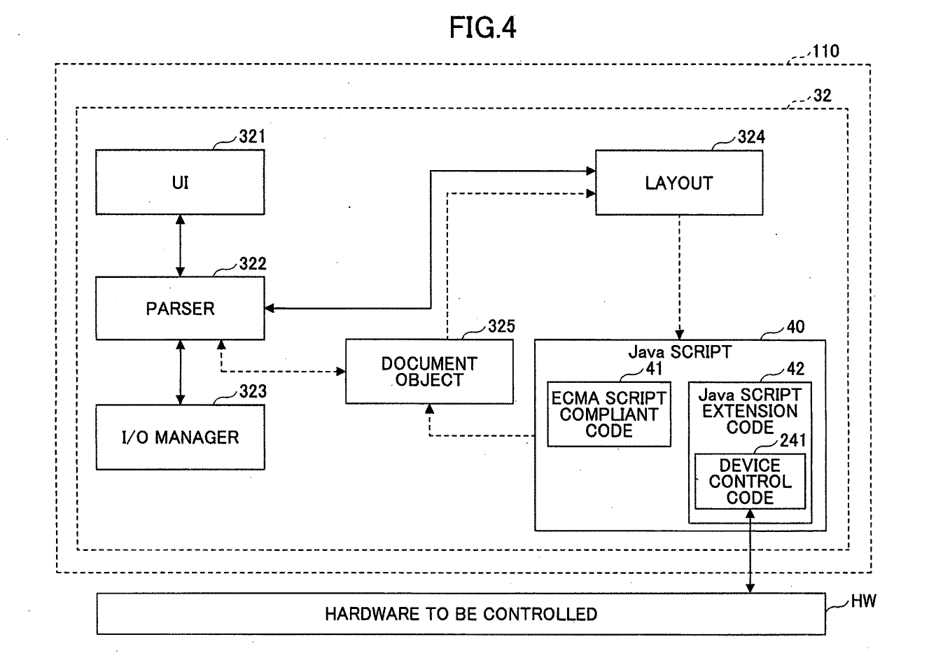

Next, a software configuration of convention display control is described. FIG. 4 shows an example of the software configuration of conventional display control.

As shown in FIG. 4, in a conventional configuration, the browser 32 includes Java script 40. The Java script 40 includes Java script extension code 42 including device control code 241.

First, a software configuration of the browser 32 is described. In this embodiment, an example is described where the Esprit is used as an embedded browser designed to run regardless of the OS and the CPU. Referring back to FIG. 4, the browser 32 includes a UI (User Interface) 321, a parser 322, an I/O manager 323, a layout 324, and a document object module (DOM) 325.

The UI 321 is a user interface of the browser 32. The parser 322 analyzes content data written in HTML, cHTML, XHTMLBasic and the like, and develops the analysis result in (i.e., transfers the analysis result to) the document object 325. The I/O manager 323 performs data input and output to and from a network (such as HTTP (HyperText Transfer Protocol) and SSL (Secure Sockets Layer)), a file, and a file cache. The layout 324 arranges the object on a display menu based on the analysis result developed in the document object 325 by the parser 322. The document object 325 is an API (Application Program Interface) enabling an HTML document and an XML (eXtensive Markup Language) document defined by W3C (World Wide Web Consortium) to be used by an application.

Further, as described above, the browser 32 supports the Java script 40 as a script language running on the browser 32. The Java script 40 may be classified broadly into an ECMA (European Computer Manufacturer Association) script compliant code 41 and a Java script extension code 42. The ECMA script compliant code 41 is a standardized code provided to overcome such problems as there being some functions that may not be used in a specific browser 32 and that even the same program runs in different ways depending on the browsers. On the other hand, the Java script extension code 42 is written by the supplier based on its own specifications. In other words, by using the Java script extension code 42, a dedicated function based on the specification may be implemented.

In a conventional image processing apparatus, all the above software is executed by the CPU 111 (the same control section) of the controller 110. By doing this, in the conventional image processing apparatus, the Java script extension code 42 directly calls the device control code 241 corresponding to a request so that the called device control code 241 may be executed to operate the hardware HW to be controlled. Namely, in the conventional image processing apparatus, a device may be controlled based on a user's request via the browser 32 by executing the Java script extension code 42 (see FIG. 4).

On the other hand, in the image processing apparatus 100 according to the embodiment of the present invention, as shown in FIG. 2, the display device 120 and the controller 110 have their respective (separate) control sections (CPUs). Further, the browser 32 is executed by the CPU 1 of the display device 120, and the device control code 241 is executed by the CPU 111 of the controller 110. Because of this configuration, the Java script extension code 42 in the browser 32 cannot directly perform (execute) device control.

To overcome the inability, in the image processing apparatus 100 according to the embodiment of the present invention, there is provided a communication function described below connecting the display device 120 and the image processing apparatus 100 so that the display device 120 may transmit a request to the image processing apparatus 100 to perform device control.

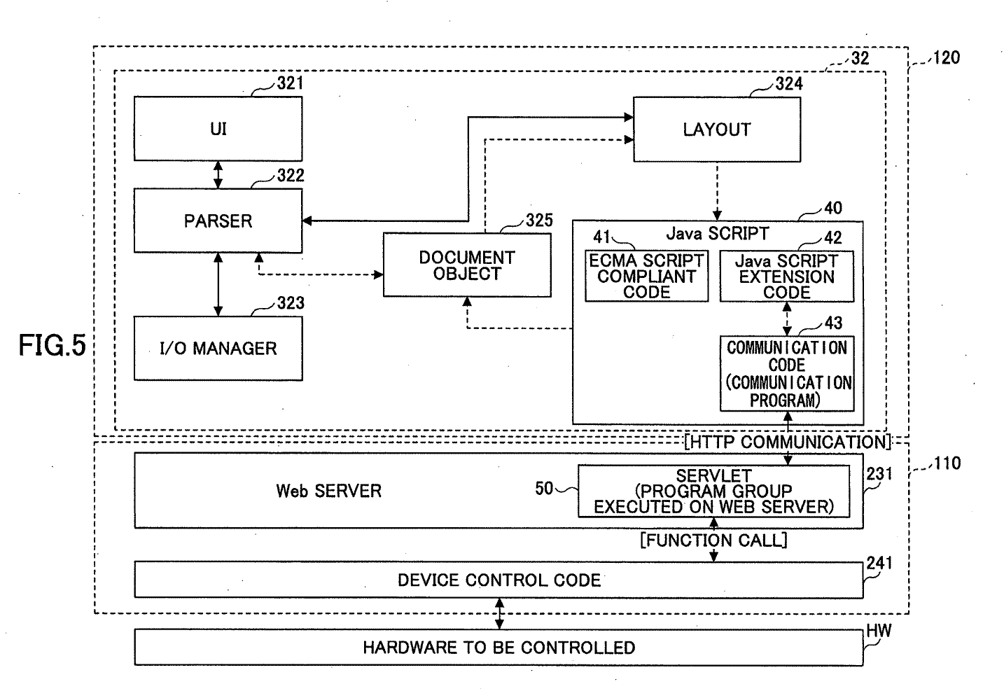

FIG. 5 shows an exemplary software configuration for performing the display control in the image processing apparatus 100 according to the embodiment of the present invention. As shown in FIG. 5, the display device 120 includes a communication program (43) to communicate with the controller 110 of the image processing apparatus 100. Herein the communication program is called communication code 43 of the Java script 40. Further, in the image processing apparatus 100, there is provided a Web server 231 running on the controller 110. Further, the Web server 231 includes a servlet 50. The servlet 50 herein refers to a modularized (segmented) Java program that runs on the Web server 231. This configuration serves as the communication function connecting between the display device 120 and the image processing apparatus 100.

In the image processing apparatus 100, the device control is performed (executed) by the following procedure. First, the communication code 43 is executed on the browser 32 to transmit a request to perform device control to the servlet 50 of the Web server 231. Then, the servlet 50 calls the device control code 241 based on the request to perform the device control. By doing in this way, in the image processing apparatus 100, it may become possible to perform the device control from the browser 32 by using existing device control code 241.

In this embodiment, as the communication function connecting between the display device 120 and the image processing apparatus 100, the HTTP communication that readily enables the communications between the browser 32 and the Web server 231 is used. However, the communication function is not limited to this HTTP communication. For example, any other appropriate communication such as socket communication may be alternatively used as the communication function.

As described above, in the image processing apparatus 100 according to the embodiment of the present invention, even when the display device 120 and the image processing apparatus 100 have the respective (separate) control sections (CPUs), the environment where the device control is performed via the display menu may be achieved by, for example, easier development of the software.

In the following, a configuration and operations of the above device control function are described.

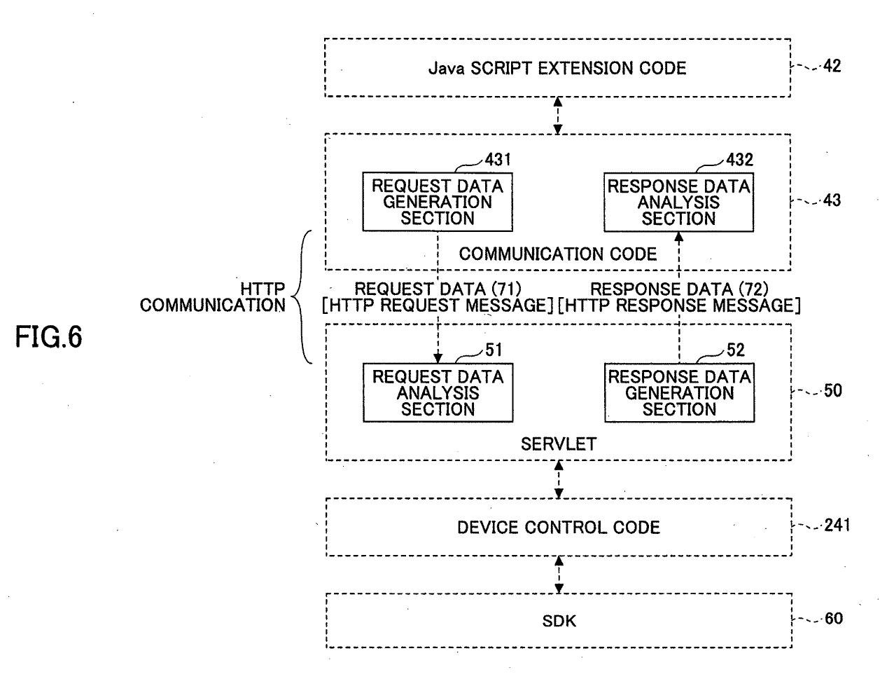

FIG. 6 shows an exemplary configuration of the device control function in the image processing apparatus 100 and the display device 120 according to an embodiment of the present invention.

As shown in FIG. 6, the communication code 43 of the display device 120 mainly serves as a request data generation section 431 and a response data analysis section 432. On the other hand, the servlet 50 of the image processing apparatus 100 mainly serves as a request data analysis section 51 and a response data generation section 52. Namely, those functions of the sections are performed (realized) by executing the communication code 43 or the servlet 50.

In the display device 120, the Java script extension code 42 performing a device control process is executed in the browser 32. According to the embodiment of the present invention, in the Java script extension code 42, there is at least one defined request process, which is an information setting process (hereinafter simplified as “setting”), an information acquisition process (hereinafter simplified as “acquisition”), or a function execution process (hereinafter simplified as “execution”). For example, a “setting” request process is a request to set an operating condition, an operating mode and the like. An “acquisition” request process is a request to acquire a setting value and the like. An “execution” request process is a request to execute a function of the image processing apparatus 100 and the like.

The communication code 43 generates request data 71 in response to the request process of the Java script extension code 42, and transmits the request data 71 to the image processing apparatus 100. By doing this, the communication code 43 transmits the request to the image processing apparatus 100 to execute the device control process. The request data 71 are generated in the request data generation section 431 of the communication code 43.

More specifically, the request data generation section 431 generates the request data 71 requesting to perform the device control process of at least one of “setting”, “acquisition”, and “execution” based on the executed request process (a process executed on the browser 32).

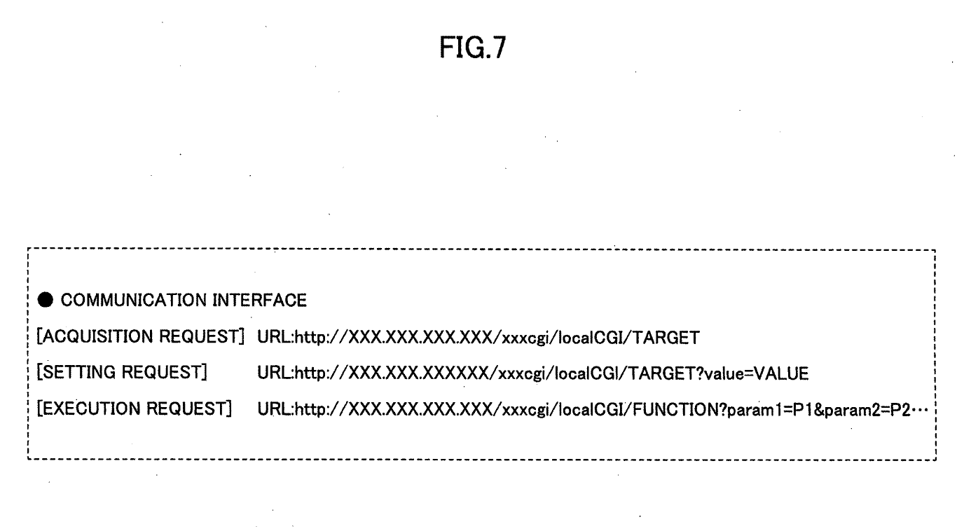

FIG. 7 shows an example of communication interface data used in this embodiment of the present invention. By using such communication interface data as shown in FIG. 7, the request data' generation section 431 generates the request data 71. Details of the generation of the request data 71 are described below.

The request data generation section 431 generates the request data 71 by designating (using) a request URL (Uniform Resource Locator) as the requesting device control process based on the executed request process (the process executed on the browser 32). In this embodiment, as described above, the HTTP is used as the communication function (communication protocol). Therefore, an HTTP request message is generated.

For example, in a case of the “acquisition” request process, the request data generation section 431 designates the “acquisition” request process by using (designating) the request URL “http://XXX.XXX.XXX.XXX/xxxcgi/localCGI/TARGET” as shown in FIG. 7. In this case, the request data generation section 431 designates an information item to be acquired by using the part of “TARGET” in the request URL. Further, in this embodiment, it is assumed that the image processing apparatus 100 has the localCGI function as an existing operating environment of the same control section. Because of this feature, in the example of the data in FIG. 7, the path “/xxxcgi/localCGI/TARGET” is used to designate the information item to be acquired by the “acquisition” request process.

Further, in a case of the “setting” request process, the request data generation section 431 designates the “setting” request process by using (designating) the request URL “http://XXX.XXX.XXX.XXX/xxxcgi/localCGI/TARGET?value=VALUE” as shown in FIG. 7. What differs from the case of the “acquisition” request process is that a value to be set (setting value) is designated in the part of “VALUE” in addition to the designation of the information item to be set by using the part of “TARGET”.

Further, in a case of the “execution” request process, the request data generation section 431 designates the “execution” request process by using (designating) the request URL “http://XXX.XXX.XXX.XXX/xxxcgi/localCGI/FUNCTION?para m1=P1&param2=P2 . . . ” as shown in FIG. 7. What differs from the cases of the “acquisition” request process and the “setting” request process is that the function to be executed is designated by using the part of “FUNCTION”, and one or more parameters to call the function are designated by using at least one of “P1”, “P2”, and the like.

Further, the setting value to be used in “VALUE” and the parameter value to be used in “Pn” (n=1,2, . . . ) are execution parameters designated (set) in the Java script extension code 42 requesting the device control process.

As described above, the request data generation section 431 generates the request data 71 requesting the device control process by designating the request URL (the communication interface corresponding to the request process).

Further, as described above, in the display device 120, the request data 71 are generated by executing the communication code 43 in the browser 32. Then, the generated request data 71 are transmitted as the HTTP request message to the image processing apparatus 100.

On the other hand, the request data 71 transmitted from the display device 120 are received by the Web server 231 running on the controller 110 in the image processing apparatus 100. The received request data 71 are analyzed by the servlet 50 running on the Web server 231. This analysis of the request data 71 is performed by the request data analysis section 51 of the servlet 50.

The request data analysis section 51 analyzes the request data 71 based on the communication protocol (in this case, HTTP protocol). As a result of the analysis, the request data analysis section 51 acquires the request of the device control process and designated information at the request.

The servlet 50 executes the corresponding device control code 241 based on the result of the analysis. Specifically, based on the acquired request of the device control process, the servlet 50 specifies and calls the corresponding device control code 241. In this case, the servlet 50 uses the designated information at the request as the execution parameter.

In the image processing apparatus 100, by executing the device control code 241 as described above, it becomes possible to control the hardware HW to be controlled via a SDK (Software Development Kit) 60.

Further, the servlet 50 generates response data 72 in response to an execution result of the device control code 241, and transmits the generated response data 72 to the display device 120 as a response of the device control process to the requestor (browser 32). The response data 72 are generated by the response data generation section 52 of the servlet 50.

Specifically, the response data generation section 52 generates the response data 72 based on at least one of the execution result of the “setting” request process, the “acquisition” request process, and the “execution” request response. In this embodiment, an HTTP response message is generated as the response data 72.

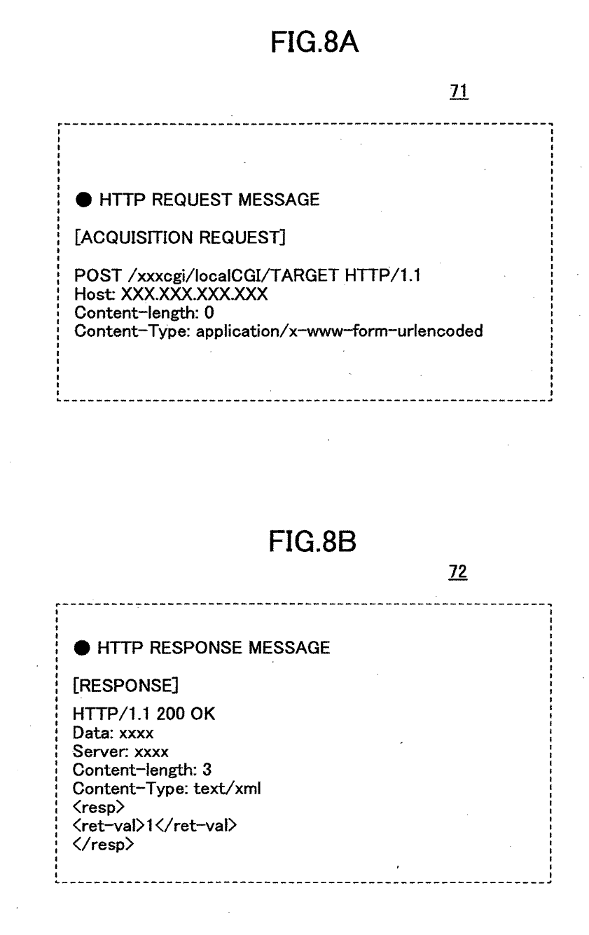

FIGS. 8A, 9A, and 10A show examples of the request data 71, and FIGS. 8B, 9B, and 10B show examples of the response data 72, respectively.

FIGS. 8A and 8B show the request data 71 and the response data 72, respectively, to be used in the “acquisition” request process.

In the case of the “acquisition” request process, the request data generation section 431 of the communication code 43 in the display device 120 generates the request data 71 as shown in FIG. 8A. In this case, as shown in FIG. 8A, the request data 71 for the “acquisition” request process has an empty request body. The request data 71 generated in the display device 120 are transmitted to the image processing apparatus 100 in a form of the HTTP request message.

When the request data 71 are received by the Web server 231 in the image processing apparatus 100, the request data analysis section 51 of the servlet 50 acquires an acquisition request based on the information indicated in the part (information item) of the “TARGET” in the HTTP request message. Then, the response data generation section 52 of the servlet 50 in the image processing apparatus 100 generates the response data 72 as shown in FIG. 8B. In this case, the response data generation section 52 generates the response data 72 based on the execution result of the acquisition of the information item of the “TARGET”. FIG. 8B shows an example of the response data 72 in which a current setting value “1” is defined in its response body, the current setting value “1” being obtained based on the execution result of the acquisition of the information item of the “TARGET”. The response data 72 generated in the image processing apparatus 100 are transmitted to the display device 120 in a form of the HTTP response message.

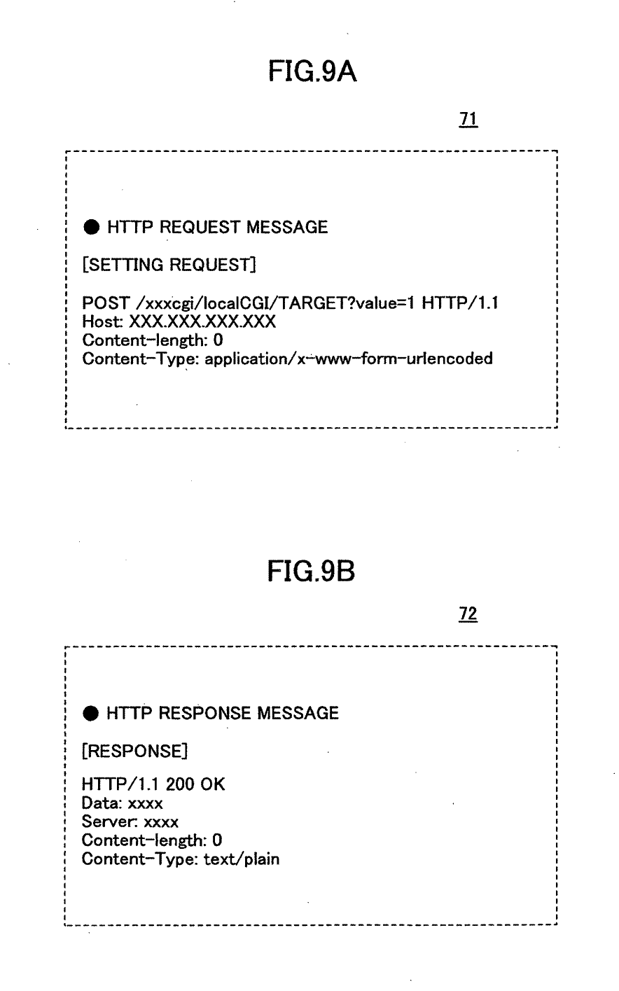

FIGS. 9A and 9B show the request data 71 and the response data 72, respectively, used in the “setting” request process.

In the case of the “setting” request process, the request data generation section 431 of the communication code 43 in the display device 120 generates the request data 71 as shown in FIG. 9A. In this case, as shown in FIG. 9A, the request data 71 for the “setting” request process has also the empty request body. The request data 71 generated in the display device 120 are transmitted to the image processing apparatus 100 in a form of the HTTP request message.

When the request data 71 are received by the Web server 231 in the image processing apparatus 100, the request data analysis section 51 of the servlet 50 acquires an acquisition request based on the information indicated in the part (information item) of the “TARGET” and the setting value “1” in the HTTP request message. Then, the response data generation section 52 of the servlet 50 in the image processing apparatus 100 generates the response data 72 as shown in FIG. 9B. FIG. 9B shows an example of the response data 72 indicating that the setting indicated in the part (information item) of the “TARGET” has been successfully completed. Further, as shown in FIG. 9B, the response data 72 has an empty response body similar to the request data 71. The response data 72 generated in the image processing apparatus 100 are transmitted to the display device 120 in a form of the HTTP response message.

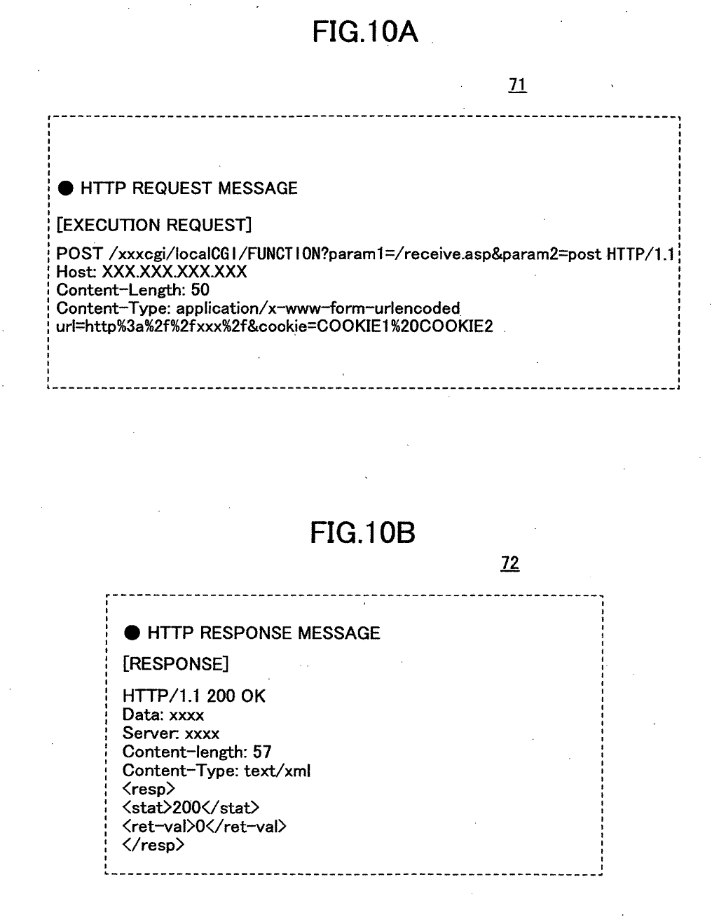

FIGS. 10A and 10B show the request data 71 and the response data 72, respectively, used in the “execution” request process.

In the case of the “execution” request process, the request data generation section 431 of the communication code 43 in the display device 120 generates the request data 71 as shown in FIG. 10A. FIG. 10A shows an example of the request data 71 in which a URL and a cookie of a page currently displayed are defined in the request body. The request data 71 generated in the display device 120 are transmitted to the image processing apparatus 100 in a form of the HTTP request message.

When the request data 71 are received by the Web server 231 in the image processing apparatus 100, the request data analysis section 51 of the servlet 50 acquires an execution request having a function name “FUNCTION” and parameter values “/receive.asp” and “post” for calling the function. Then, the response data generation section 52 of the servlet 50 in the image processing apparatus 100 generates the response data 72 as shown in FIG. 10B. In this case, the response data generation section 52 generates the response data 72 based on the execution result of the function having the name “FUNCTION”. FIG. 10B shows an example of the response data 72 in which an execution result code value “200” and an execution result value “0” which are obtained by the execution of the function having the name “FUNCTION” are defined in the response body. The execution result code indicates whether the execution of the requested function has been successfully completed. The execution result value is obtained as the execution result of the function. The response data 72 generated in the image processing apparatus 100 are transmitted to the display device 120 in a form of the HTTP response message.

As described above, in the image processing apparatus 100 according to this embodiment of the present invention, the request process (device control process) transmitted from the display device 120 is executed by the servlet 50 running on the Web server 231, and the response data 72 generated based on the execution result are transmitted back (sent) to the display device 120 in a form of the HTTP response message.

Further, in the display device 120, the browser 32 receives the response data 72 from the image processing apparatus 100. The received response data 72 are analyzed by the communication code 43 running in the browser 32. Specifically, the received response data 72 are analyzed by the response data analysis section 432 of the communication code 43.

The response data analysis section 432 analyzes the response data 72 based on the communication protocol (in this case, HTTP protocol). As a result of the analysis, the response data analysis section 432 obtains execution result information of the request process. By doing in this way, the browser 32 running in the display device 120 obtains a processing result of the requested device control process.

As described above, in this embodiment, the device control process is achieved by joint collaboration of the above functional sections.

Specifically, the device control function is executed by loading a device control program installed in the image processing apparatus 100 and the display device 120 from a storage (such as the ROM) to the RAM by the respective CPUs 111 and 1, and executing the processes described below.

In the following, detailed operations of the device control function (joint collaboration of functional sections) are described with reference to a sequence diagram illustrating the procedure of the operations. The procedure of the operations is described based on an example of the device control process when a scanning operation is performed (i.e., when a draft is read). Further, for explanatory purposes, the device control process is divided into two processes P1 and P2. The process P1 starts when a setting menu of the scanning operation is displayed and ends when preparation for receiving a start request is completed. The process P2 starts when the start request is received and ends when the scanning operation is completed. In the following, the processes P1 and P2 are described separately.

### Process P1

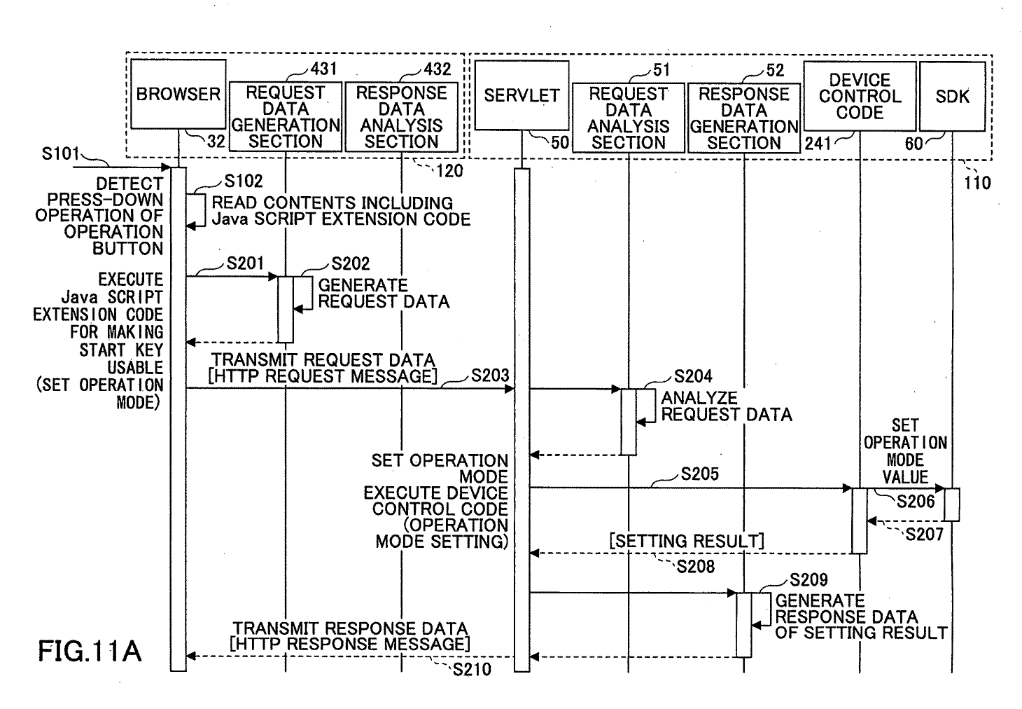

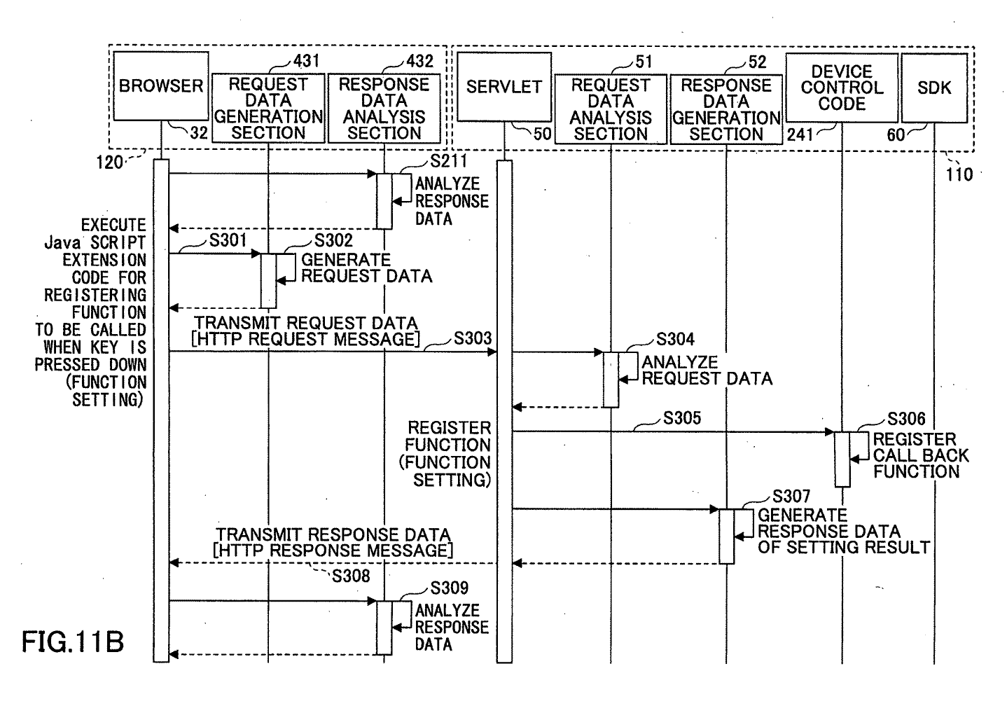

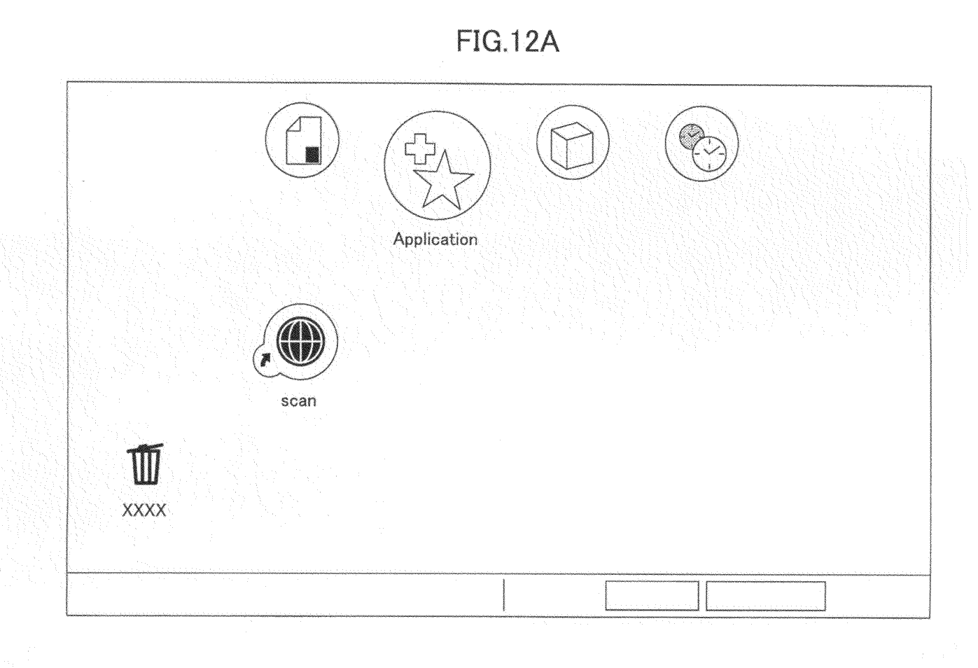

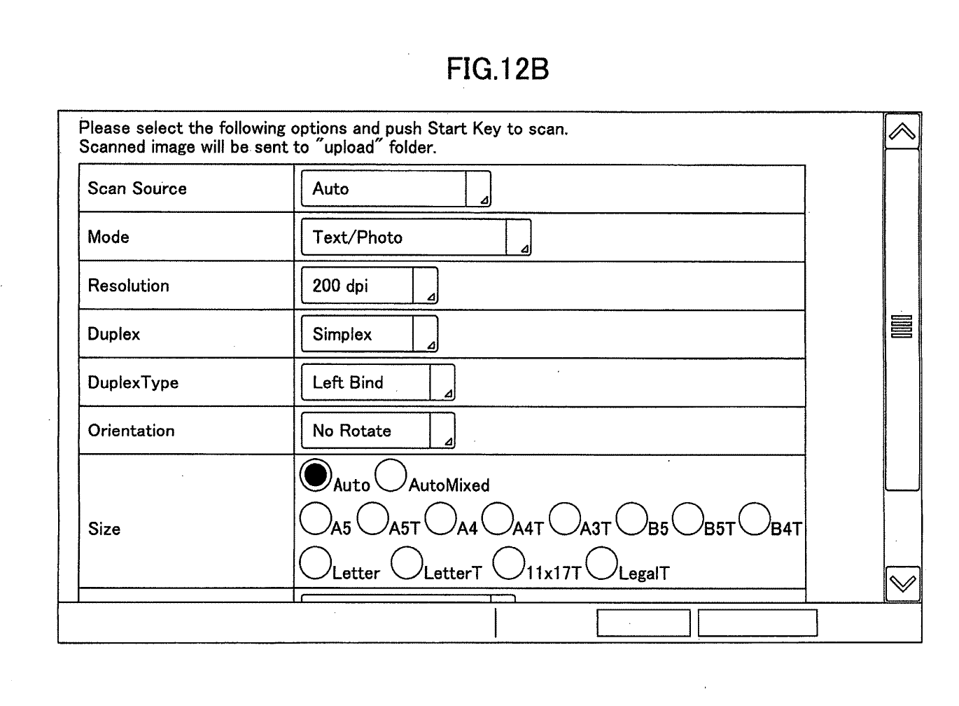

FIGS. 11A and 11B are a sequence diagram illustrating the procedure of an initial operation of the device control process (P1) according to this embodiment of the present invention. Further, FIGS. 12A and 12B show examples of display menus in the initial operation of the device control process (P1).

As shown in FIGS. 11A and 11B, first, the browser 32 running in the display device 120 detects a press-down operation of an operation button on a GUI performed by a user (step S101). For example, when a GUI as shown in FIG. 12A is displayed on a display menu of the display device 120, the browser 32 detects the press-down operation of the [scan] button by detecting the issue of the corresponding event.

The browser 32 reads contents associated with the operation button based on the detection result of the press-down operation of the operation button (step S102). For example, when the press-down operation is detected, the browser 32 reads the contents for displaying a scanning operation setting menu. As the contents, HTML data may be used. Further, the contents includes a control code (e.g., “definition of display parts” and “definition of layout”) generating a menu to be displayed when an operation button is pressed down, and the Java script extension code 42 for scanning operation. The contents may be read by designating a URL indicating the storage destination of the contents by using the browser 32. To that end, the contents are stored in a storage device in the image processing apparatus 100 or an external device (e.g., an information processing apparatus connected the image processing apparatus 100 via a network). By having this configuration, a scanning operation setting menu as shown in FIG. 12B may be displayed on the display menu of the display device 120 via the browser 32.

Further, the browser 32 performs a process related to the device control process in accordance with the read contents. In a case of the scanning function, the process P1 from displaying the setting menu to completing the preparation for receiving the start request is performed as described below.

First, the browser 32 executes the Java script extension code 42 included in the contents to make it possible to use a start key to start the scanning operation (step S201). Then, the request data generation section 431 of the communication code 43 in the browser 32 generates the request data 71 based on the request process performed by executing the Java script extension code 42 (step S202). For example, when the browser 32 executes the Java script extension code 42 to set an operation mode value to “1” to make it possible to use the start key, the request data generation section 431 may designate the request URL “http://XXX.XXX.XXX.XXX/xxxcgi/localCGI/TARGET?value=“1” for the “setting” request process. By doing in this way, the browser 32 generates the HTTP request message for requesting the operation mode setting as the request data 71.

Next, the browser 32 transmits the request data 71 generated by the request data generation section 431 to the image processing apparatus 100 (servlet 50 running on the Web server 231) (step S203). The transmitted request data 71 are received by the Web server 231 running on the controller 110 in the image processing apparatus 100. By doing this, in this embodiment, a request to set the operation mode is transmitted from the display device 120 to the image processing apparatus 100.

In the image processing apparatus 100, the request data analysis section 51 of the servlet 50 analyzes the request data 71 received by the Web server 231 (step S204). As the analysis result, the servlet 50 obtains the process request of the operation mode setting and the operation mode value “1” designated at the request.

Then, the servlet 50 calls and executes the device control code 241 for setting the operation mode based on the obtained process request (step S205). In this case, the servlet 50 uses the obtained operation mode value “1” as the execution parameter.

In the image processing apparatus 100, the operation mode value “1” is set as the corresponding parameter value in the SDK 60 by the device control code 241 (step S206). In this case, the device control code 241 calls a module (function) in the SDK 60 to set the corresponding parameter value in the SDK 60. As a result, the image processing apparatus 100 obtains the setting result of the operation mode (steps S207 and S208).

The response data generation section 52 of the servlet 50 generates the response data 72 to report the setting result of the operation mode to the requestor (browser 32) (step S209). In this case, the response data generation section 52 generates the

HTTP response message based on the obtained setting result of the operation mode as the response data 72 in response to the HTTP request message at the request.

The servlet 50 transmits the response data 72 generated by the response data generation section 52 to the display device 120 (browser 32) (step S210). The transmitted response data 72 are received by the browser 32 running in the display device 120. By doing in this way, in this embodiment, the setting result of the operation mode requested by the display device 120 to be provided by the image processing apparatus 100 is sent (transmitted back) to the display device 120.

The response data analysis section 432 of the communication code 43 analyzes the received response data 72 (step S211). By doing this, the browser 32 obtains the processing result (OK/NG) of setting the operation mode.

Next, the browser 32 executes the Java script extension code 42 for registering a function called when the start key is pressed down, the Java script extension code 42 being included in the contents (step S301). In the browser 32, based on the request process performed by executing the Java script extension code 42, the request data generation section 431 of the communication code 43 generates the request data 71 (step S302). For example, in the browser 32, when the Java script extension code 42 is executed for registering a function [my_scan( )] called when the start key is pressed down, the request data generation section 431 may designate the request URL “http://XXX.XXX.XXX.XXX/xxxcgi/localCGI/TARGET?value=my_scan” of the “setting” request process. By doing in this way, in the browser 32, the HTTP request message for requesting the setting of the function registration is generated as the request data 71.

The browser 32 transmits the request data 71 generated by the request data generation section 431 to the image processing apparatus 100 (the servlet 50 running on the Web server 231) (step S303). The transmitted request data 71 are received by the Web server 231 running on the controller 110 in the image processing apparatus 100. By doing this, in this embodiment, the display device 120 requests the image processing apparatus 100 to set the registration of the function.

In the image processing apparatus 100, the request data analysis section 51 of the servlet 50 analyzes the request data 71 received by the Web server 231 (step S304). As the analysis result, the servlet 50 obtains the process request for setting of the function registration and the registered function name [my-scan] at the request.

The servlet 50 sets the function name of the parameters and registers the function based on the obtained process request (step S305). The servlet 50 sets the registered function name [my_scan] as a function (call back function) to be called from the device control code 241 to be executed when the start key is pressed down (step S306).

In the servlet 50, the response data generation section 52 generates the response data 72 to respond to the setting result of the function registration to send to the requestor (browser 32) (step S307). In this case, based on the obtained setting result of the function registration, the response data generation section 52 generates the HTTP response message as the response data 72 in response to the HTTP request message generated at the request.

The servlet 50 transmits the response data 72 generated by the response data generation section 52 to the display device 120 (browser 32) (step S308). The transmitted response data 72 are received by the browser 32 running in the display device 120. By doing this, in this embodiment, the setting result of the function registration requested by the display device 120 to be provided by the image processing apparatus 100 is sent (transmitted back) to the display device 120.

In the browser 32, the response data analysis section 432 of the communication code 43 analyzes the received response data 72 (step S309). By doing this, the browser 32 obtains the processing result (OK/NG) of setting the function registration.

As described above, in this embodiment, by transmitting and receiving the request data and the response data between the display device 120 and the image processing apparatus 100, the device control of the initial operation (pre-operation of displaying the scanning operation setting menu and receiving the request to start the scanning operation) may be performed.

### Process P2

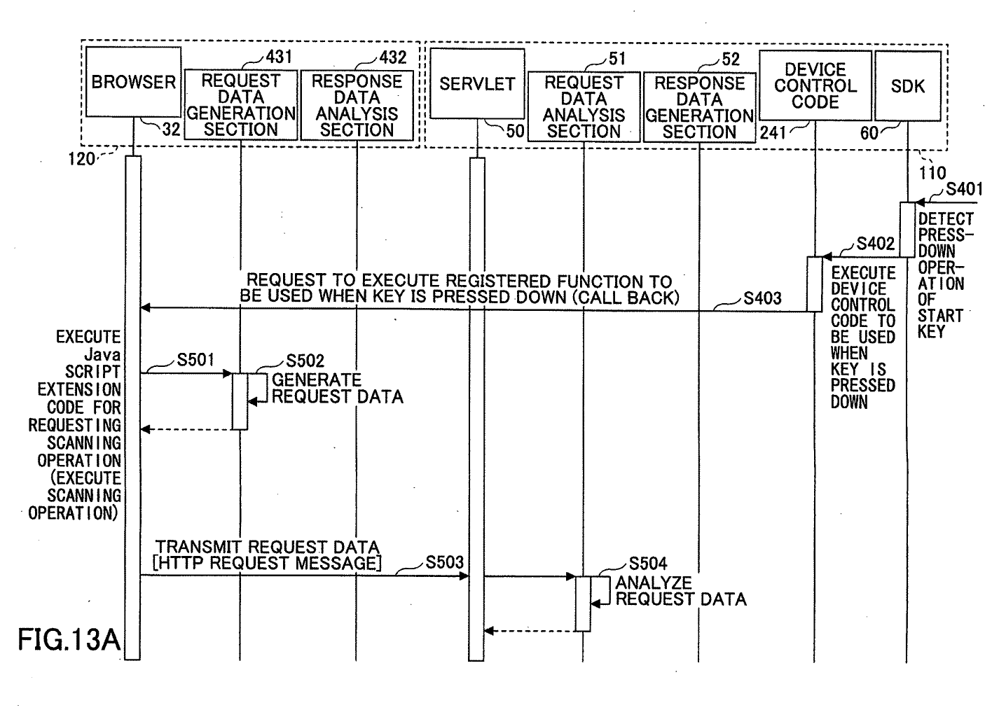

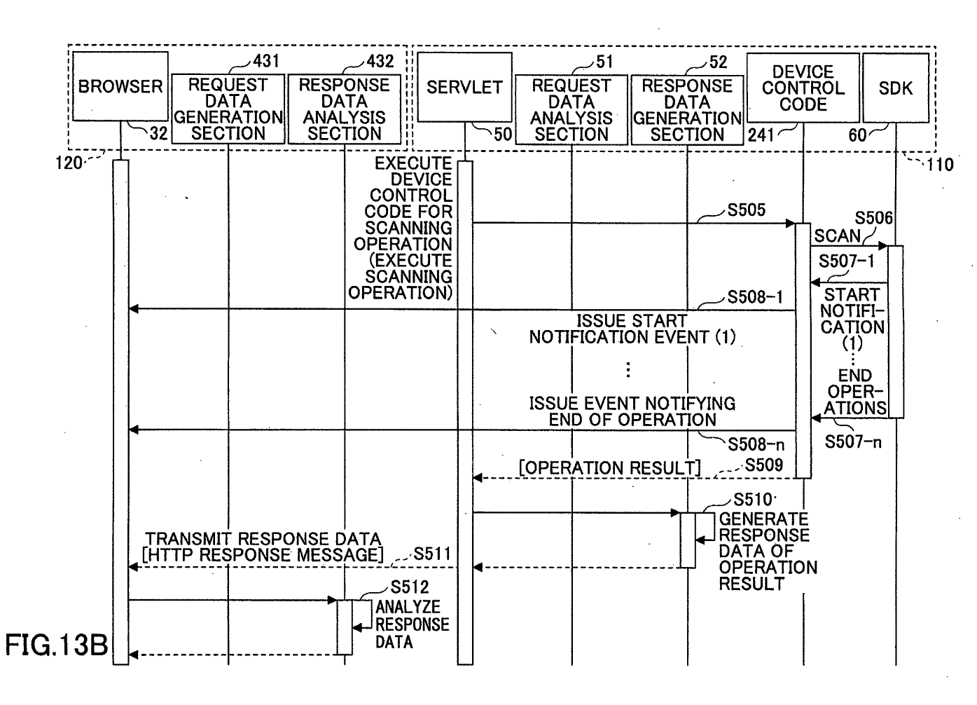

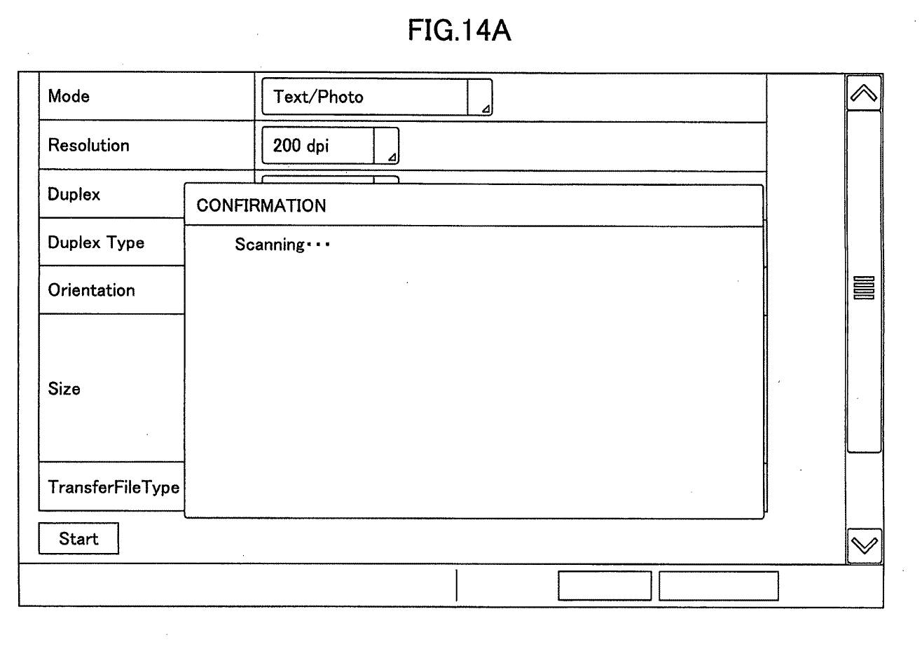

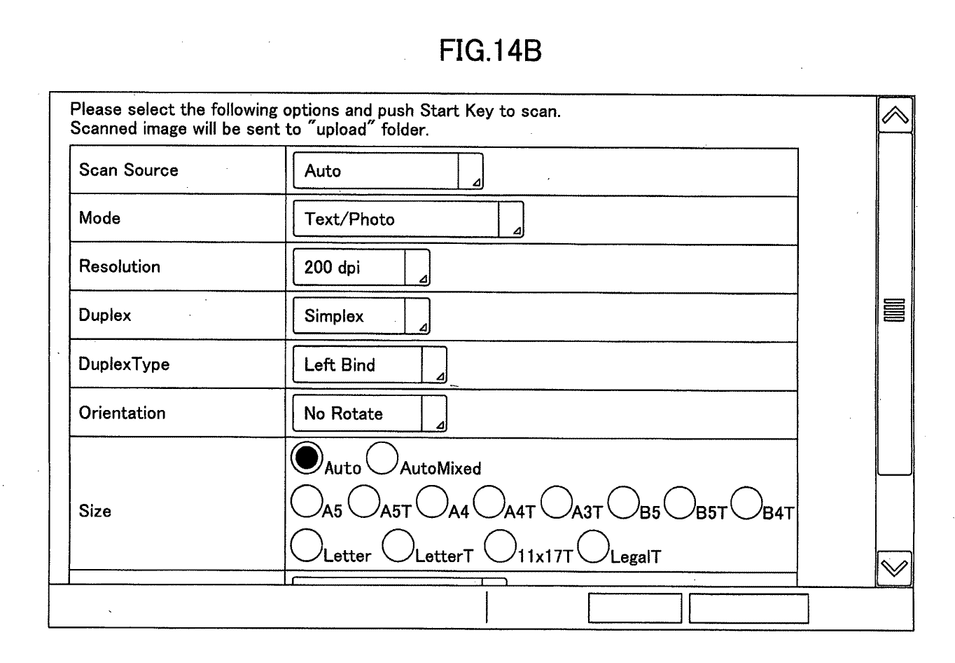

FIGS. 13A and 13B are a sequence diagram illustrating the procedure of a function execution operation of the device control process (P2) according to this embodiment of the present invention. Further, FIGS. 14A and 14B show examples of display menus in the function execution operation of the device control process (P2).

As shown in FIGS. 13A and 13B, first, when the user presses down the start key (hard key) provided as an input interface of the image processing apparatus 100, the SDK 60 detects this user's operation (step S401). In this case, the SDK 60 detects the user's operation based on the issue of the corresponding event.

After detecting the press-down of the start key by the SDK 60, the image processing apparatus 100 executes the corresponding device control code 241 which is to be executed when the start key is pressed down (step S402). As a result, in the image processing apparatus 100, the corresponding registered function is called back and a request to execute the function (call back function) which is to be called when the start key is pressed down is transmitted to the display device 120 (step S403).

Based on the execution request from the image processing apparatus 100, the display device 120 performs the corresponding device control process. In the scanning operation, the process from receiving a start request to the completion of the scanning may be executed as described below.

First, the browser 32 executes the Java script extension code 42 to request for the scanning operation (step S501). In the browser 32, based on the request process specified by executing the Java script extension code 42, the request data generation section 431 of the communication code 43 generates the request data 71 (step S502). For example, when the browser 32 executes the. Java script extension code 42 to set parameter values [UploadServlet], [post], and [currentPage] to request for the scanning operations, the request data generation section 431 may designate the request URL “http://XXX.XXX.XXX.XXX/xxxcgi/localCGI/FUNCTION?para m1=UploadSevlet&param2=post&param3=currentPage” of the “execution” request process. By designating in this way, the browser 32 generates the HTTP request message to request for the scanning operation as the request data 71.

The browser 32 transmits the request data 71 generated by the request data generation section 431 to the image processing apparatus 100 (the servlet 50 running on the Web server 231) (step S503). The transmitted request data 71 are received by the Web server 231 running on the controller 110. By doing in this way, in this embodiment, the display device 120 requests the image processing apparatus 100 to execute the scanning operation.

In the image processing apparatus 100, the request data analysis section 51 of the servlet 50 analyzes the request data 71 received by the Web server 231 (step S504). As the analysis result, the servlet 50 obtains the process request for executing the scanning operation and the parameter values [UploadServlet], [post], and [currentPage] designated at the request.

The servlet 50 calls and executes the corresponding device control code 241 which is to be executed when the scanning operation is to be executed (step S505). In this case, the servlet 50 uses the obtained parameter values [UploadServlet], [post], and [currentPage] as the execution parameters.

In the image processing apparatus 100, by executing the device control code 241, a scanning module in the SDK 60 is executed based on the execution parameters (step S506). In this case, the scanning module in the SDK 60 is executed by calling the scanning module (function) in the SDK 60 by the device control code 241. As a result, the image processing apparatus 100 obtains a start notification of the scanning operation (Step S507-1). The processing apparatus 100 issues an event to be reported to the display device 120 based on the start notification (Step S508-1). Further, in the image processing apparatus 100, the start notification of the scanning operation is periodically sent via the SDK 60; as a result, the event is also periodically reported to the display device 120.

By doing in this way, a scanning operation menu (menu indicating an executing status) as shown in FIG. 14A is displayed on the display menu of the display device 120 via the browser 32. For example, the scanning operation menu is being displayed while the event to start the scanning operation is received from the image processing apparatus 100.

Further, when a notification indicating the end of the scanning operation is sent via the SDK 60 (step S507-n), the image processing apparatus 100 issues an event to report the end of the scanning operation to the display device 120 (step S508-n), and obtains the execution result of the scanning operation (step S509).

As a result, such a scanning operation setting menu as shown in FIG. 14B is displayed on the display menu of the display device 120. Namely, the display menu is returned to its previous state when the start request is not received as shown in FIG. 12B.

Further, in the image processing apparatus 100, when the event to report the end of the scanning operation is issued, the response data generation section 52 of the servlet 50 generates the response data 72 to send the execution result of the scanning operation to the requestor (browser 32) (step S510). In this case, the response data generation section 52 generates the HTTP response message based on the obtained execution result of the scanning operation as the response data 72 in response to the HTTP request message at the request.

The servlet 50 transmits the response data 72 generated by the response data generation section 52 to the display device 120 (browser 32) (step S511). The transmitted response data 72 are received by the browser 32 running in the display device 120. By doing in this way, in this embodiment, the execution result of the scanning operation requested by the display device 120 to be provided by the image processing apparatus 100 is sent (transmitted back) to the display device 120.

In the browser 32, the response data analysis section 432 of the communication code 43 analyzes the received response data 72 (step S512). By doing this, the browser 32 obtains the processing result (OK/NG) of the request for scanning operation.

As described above, in this embodiment, by transmitting and receiving the request data and the response data between the display device 120 and the image processing apparatus 100, the device control of the function execution operation (scanning process) may be performed.

### SUMMARY

As described above, in the image processing apparatus 100 according to this embodiment of the present invention, the communication code 43 executed on the browser 32 running in the display device 120 requests the Web server 231 running on the controller 110 to perform the device control. In this case, in the image processing apparatus 100, the request data generation section 431 of the communication code 43 generates the request data 71 in response to the request for processing (executing) the device control.

After that, in the image processing apparatus 100, the servlet 50 running on the Web server 231 calls the device control code 241 in response to the request, and reports (transmits back) the execution result to the requestor (browser 32). In this case, in the image processing apparatus 100, the request data analysis section 51 of the servlet 50 analyzes the request data 71, and calls the device control code 241 for performing the request process based on the analysis result. Further in the image processing apparatus 100, the response data generation section 52 of the servlet 50 generates the response data 72 to send the process result to the requestor (browser 32).

By doing in this way, in a case where the display device 120 and the image processing apparatus 100 have the respective (separate) control sections CPU 1 and CPU 111, it may become possible to perform the device control from the browser 32 by using the existing device control code 241. Because of this feature, it may become possible to reduce the workload of the designer (development engineer) when compared with the case where new development is required in a conventional image processing apparatus.

In the above described embodiment, the procedure of the “device control function” of the image processing apparatus 100 as described with reference to the drawings may be performed by executing a program coded in a programming language adapted to the operating environment (i.e., platform) by the control sections (CPU 1 and the CPU 111) of the display device 120 and the image processing apparatus 100, respectively.

The program may be stored in a computer-readable storage medium 114a. The storage medium 114a may be the SD Memory Card, the USB memory or the like.

Therefore, the program stored in the storage medium 114a may be installed in the image processing apparatus 100 via the external storage I/F 114. Further, the image processing apparatus 100 may include the network I/F 113; as a result, the program may be downloaded via electronic communication lines such as the Internet and installed. Further, the program is transmitted to and installed in the display device 120 by the controller 110 in the image processing apparatus 100 via the bus B.

Further, in this embodiment, a case is described where the “Esprit” is used as the browser 32 in the display device 120. However, the present invention is not limited to this configuration. For example, any appropriate browser that can handle the Java script may be alternatively used.

According to an embodiment of the present invention, it may become possible to use the existing device control codes which have been developed for a platform where the same single control section (CPU) is provided for the image processing apparatus and the display device without performing new development processes which may otherwise cause a higher development cost.

Further, according to an embodiment of the present invention, an image processing apparatus and a device control method are capable of performing device control via a display menu with simpler development work by using a communication function connecting between the display device and the image processing apparatus, the display device requesting the image processing apparatus to execute the device control even when the display device and the image processing apparatus have the respective (separate) control sections (CPUs).

Although the invention has been described with respect to a specific embodiment for a complete and clear disclosure, the appended claims are not to be thus limited but are to be construed as embodying all modifications and alternative constructions that may occur to one skilled in the art that fairly fall within the basic teachings herein set forth.

What is claimed is:

1. An image processing apparatus having a display device having a control section, the image processing apparatus comprising:
a request unit configured to send a request from the display device to the image processing apparatus to execute a device control process, the request being processed based on a program executed by a browser running in the display device;
an execution unit configured to execute the device control process requested by the display unit, the execution being performed based on a program processed by a Web server running in the image processing apparatus; and
a response unit configured to send an execution result of the device control process to the display unit.

2. The image processing apparatus according to claim 1, wherein
the request unit generates request data requesting execution of the device control process, the request data being generated based on the process executed by the browser, and transmits the request data from the display device to the image processing apparatus to request for executing the device control process.

3. The image processing apparatus according to claim 2, wherein
the request unit designates a request URL (Uniform Resource Locator) corresponding to the request for executing the device control process based on the process executed by the browser, and generates a request message using the request URL as the request data.

4. The image processing apparatus according to claim 3, wherein
when an execution parameter is designated in the process executed by the browser, the request unit designates the request URL corresponding to the request for executing the device control process and the execution parameter based on the executed process and the execution parameter.

5. The image processing apparatus according to claim 2, further comprising:
a request data analysis unit configured to analyze the request data, wherein
the execution unit executes the device control process requested by the display unit, the device control process being executed based on the requested device control process included in an analysis result of the request data analyzed by and received from the request data analysis unit.

6. The image processing apparatus according to claim 1, wherein
the execution unit calls a device control program from the programs executed by the Web server, and executes the device control process requested by the display unit.

7. The image processing apparatus according to claim 1, wherein
the response unit generates a response message as response data based on the execution result of the device control process executed by the execution unit, and sends the response data to the display unit to report the execution result.

8. The image processing apparatus according to claim 7, further comprising:
a response data analysis unit configured to analyze the response data, wherein
the browser obtains the execution result of the requested device control process based on the execution result of the device control process included in the analysis result of the response data analyzed by and received from the response data analysis unit.

9. The image processing apparatus according to claim 1, wherein
the request unit requests one of an information setting process, an information acquisition process, and a function execution process as the device control process.

10. A device control method in an image processing apparatus having a display device having a control section, the device control method comprising:
a requesting step of sending from the display device to the image processing apparatus a request to execute a device control process, the request being processed based on a program executed by a browser running in the display device;
an executing step of executing the device control process requested by the display unit, the execution being performed based on a program processed by a Web server running in the image processing apparatus; and
a responding step of sending an execution result of the device control process to the display unit.
